(19) United States
(12) Patent Application Publication
(10) Pub. No.: US 2013/0339140 A1
(43) Pub. Date: Dec. 19, 2013

(54) Systems and Methods for Assessing Exposure Value of Out of Home Advertising Assets

(71) Applicant: Intermap Technologies, Inc., Englewood, CO (US)

(72) Inventors: Petr Pokorny, Praha (CZ); John Keith Tennant, Airdrie AB (CA); Patrick Edward Stevenson, Denver, CO (US)

(73) Assignee: Intermap Technologies, Inc.

(21) Appl. No.: 13/918,722

(22) Filed: Jun. 14, 2013

Related U.S. Application Data
(60) Provisional application No. 61/659,864, filed on Jun. 14, 2012.

(51) Int. Cl. G06Q 30/02; G06Q 50/16

(52) U.S. Cl. CPC G06Q 30/0251; G06Q 50/16
USPC 705/14.49

(57) ABSTRACT

Implementations described and claimed herein provide systems and methods for assessing an exposure value of an asset, such as an out of home advertising asset. In one implementation, location information for an asset at positioned at a location point is obtained. The location information reflects viewing conditions of the asset. Digital elevation model data is obtained for a region in which the location point of the asset is positioned. A viewshed is generated based on the location information and the digital elevation model data. Exposure value information is generated by intersecting the viewshed with transport information.

### CROSS-REFERENCE TO RELATED APPLICATIONS

The present application claims priority under 35 U.S.C. §119 to U.S. provisional patent application 61/659,864, which was filed Jun. 14, 2012, entitled “Estimating the Quality of Exposure of a Vertical Surface using Digital Elevation Modeling,” and is hereby incorporated by reference in its entirety into the present application.

### TECHNICAL FIELD

Aspects of the present disclosure relate to digital elevation modeling, among other functions, and more particularly to evaluations of the exposure value of out of home advertising assets.

### BACKGROUND

Companies and other entities are increasingly relying on out of home (“OOH”) advertising to reach consumers while they are outside of their homes. Generally, OOH advertising is used to market to consumers when they are in public places, in transit, in commercial or business locations, or the like. Recently, there has been a significant growth in digital OOH advertising, which disseminates dynamic media content using digital assets (e.g., billboards, screens, kiosks, and other interfaces for displaying media content).

It can be cumbersome for companies to focus and leverage their marketing budgets to maximize the value of their advertising in reaching an intended audience. Further, assessing the value of locations of OOH advertising assets is often challenging. Conventional approaches for evaluating OOH assets generally rely on physical surveying of the asset and comparing the data with demographic data of persons likely to come within the vicinity of the asset. Other conventional approaches attempt to record the faces of consumers as they pass the OOH asset to estimate the actual or likely viewing of the asset by consumers. These conventional approaches often result in companies or other entities paying large sums of money for advertising space on OOH assets that consumers are only exposed to for a very short duration.

It is with these observations in mind, among others, that various aspects of the present disclosure were conceived and developed.

### SUMMARY

Implementations described and claimed herein address the foregoing problems, among others, by providing systems and methods for assessing an exposure value of an asset, such as an out of home advertising asset. In one implementation, location information for an asset at positioned at a location point is obtained. The location information reflects viewing conditions of the asset. Digital elevation model data is obtained for a region in which the location point of the asset is positioned. A viewshed is generated based on the location information and the digital elevation model data. Exposure value information is generated by intersecting the viewshed with transport information.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example OOH advertising asset positioned along a travel segment and configured according to an assessed exposure value.

FIG. 2 is an example exposure value assessment system, including a exposure value assessment application running on a computer server or other similar device coupled with a network, for managing one or more OOH advertising assets.

FIG. 3 is a flow chart illustrating example operations for assessing the exposure value of one or more assets.

FIG. 4 shows an example user interface generated by the exposure value assessment application, the user interface being displayed in a browser window of a computing device and displaying a viewshed analysis and exposure presentation of an OOH asset to a consumer traveling along a selected travel segment.

FIG. 5 illustrates the viewshed analysis and exposure presentation of an OOH asset in the vicinity of other OOH assets.

FIGS. 6-8 show the user interface displaying viewshed analyses and exposure presentations of other OOH asset along selected travel segments.

FIGS. 9A-9D are graphs showing an effect of an exposure assessment on a duration of exposure of an asset along a travel segment.

FIG. 10 is an example of a computing system that may implement various systems and methods discussed herein.

### DETAILED DESCRIPTION

Aspects of the present disclosure involve systems and methods for assessing the exposure value of one or more OOH assets based on a geospatial analysis. In other words, aspects of the present disclosure involve determining an amount of time and a distance a consumer can see or is otherwise exposed to an OOH asset while traveling. Generally, aspects of the present disclose provide information on how an OOH is viewed and the type of consumers that are viewing it.

In one particular aspect, a location point of an OOH asset is defined by geographical coordinates, and additional location information and a digital elevation model is generated or otherwise obtained. The digital elevation model represents an elevation of terrain in the region in which the OOH is located. Stated differently, detailed elevation data of the surface of the earth or other terrain and various features projecting from such surfaces may be provided in a matrix of cells containing digital elevation model data for the geographical area in which the OOH is located. From the digital elevation model and the location information for the OOH asset, a viewshed is created. Stated differently, using location information for the OOH asset, the digital elevation model may be processed to determine where the location point connects to all other points in the digital elevation model, as limited by a radius. A line of sight is the viewshed along “one-line,” while the viewshed represents the combination of all lines of sight for the OOH asset.

The viewshed is intersected with transport information for a travel segment to obtain exposure value information. The transport information may include, without limitation, routing and speed information for the travel segment. The routing and speed information may be obtained from one or more transport databases and/or vendors and may be historical or real time. The exposure value information provides a distance and a time during which a consumer is exposed to the OOH asset along a travel segment. Further, for the OOH asset, the exposure value information may provide: an average exposure distance and time based on planned or marked speeds or historical average speed data; an average exposure distance and time for a particular time; an exposure distance and time in substantially real time based on a real time feed of speed information; a maximum exposure distance and time; a minimum exposure distance and time; statistical representations of exposure distance and time; optimal viewing locations; and the like. The optimal viewing locations correspond to locations providing a substantially continuous view along one or more travel segments as opposed to locations providing an interrupted view where the asset comes in and out of sight. The exposure value information may be presented and interacted with in a variety of formats, including, without limitation, via a user interface.

The various systems and methods disclosed herein provide for assessing the exposure value of a location, site, or asset. The example implementation discussed herein references OOH assets. However, it will be appreciated by those skilled in the art that the presently disclosed technology is applicable to other types of locations, sites, or assets. Stated differently, the presently disclosed technology may be used to determine the amount of time a person can see or is otherwise exposed to a particular location, site, or asset while traveling. Conversely, the presently disclosed technology may be used to locate sites (e.g., landfills, mines, clear cutting of trees, etc.) such that the exposure is minimized.

Further, the presently disclosed technology may be used in the security context to assess the exposure of a particular location to passing traffic. For example, information on which buildings and windows have extended viewing access to a particular location or along a particular route may be useful in focusing security assets in areas where a security risk may exist. Similarly, the presently disclosed technology may be used to assess the value of a particular viewing area, for example, during a parade or other event, based on the elevation, location, and orientation, of the viewing area. Such information may be used in determining an appropriate rent price for such areas during an event.

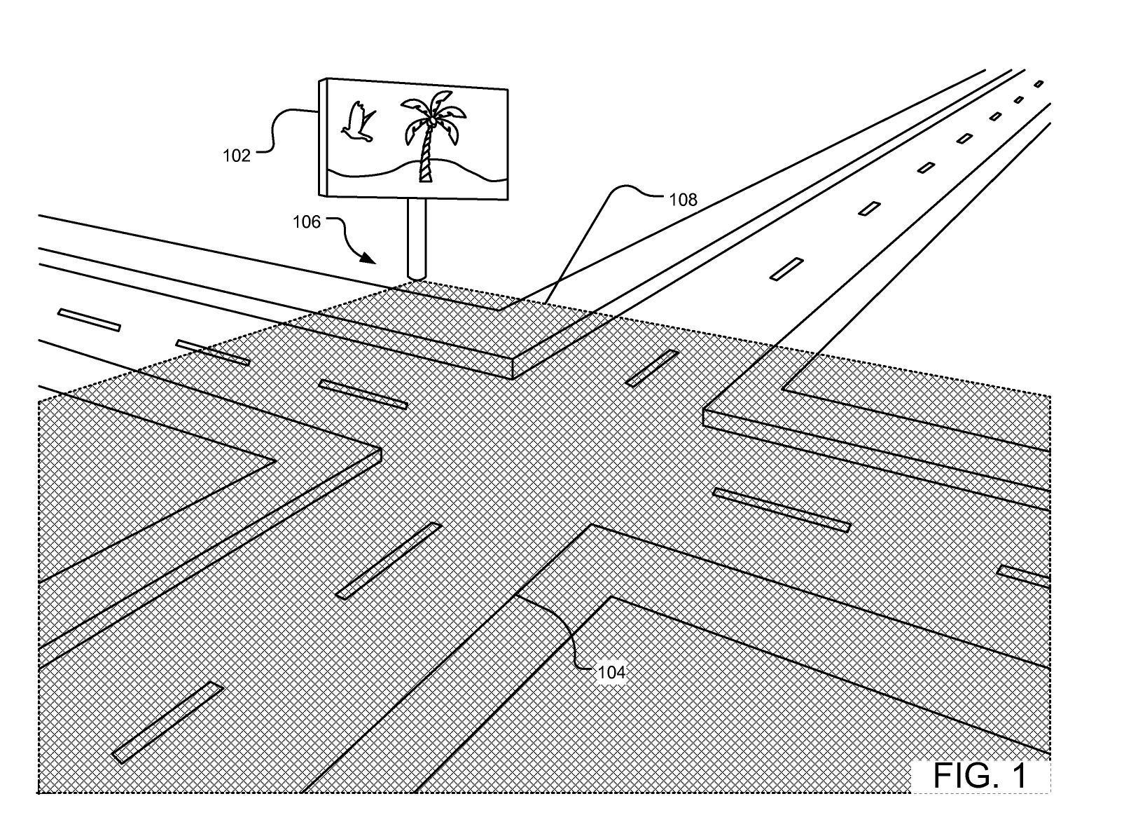

For a detailed description of an example OOH advertising asset assessed and configured in accordance with the presently disclosed technology, reference is made to FIG. 1. In one implementation, an OOH advertising asset 102 is positioned at a location point. The OOH advertising asset 102 is shown in FIG. 1 as a billboard. However, it will be appreciated that the asset 102 may be provided in a variety of advertising formats or be a location, site, attraction, event, or other type of asset. The asset 102 may or a combination of both. Further, the type of media displayed with the asset 102 may be rotating, fixed, digital, non-digital, or some combination of them.

In one implementation, the asset 102 is positioned and configured based on an assessed exposure value, which provides a distance and a time during which a potential consumer is exposed to the asset 102 along a travel segment 104. The travel segment 104 may be all or a portion of a roadway for vehicles (e.g., a street, channel, railway, waterway, etc.), a path, sidewalk, or route for pedestrian or physical travel (e.g., walking, running, bicycling, skateboarding, horseback riding etc.), train or other public transportation tracks or paths, air travel paths, or the like. The travel segment 104 may be outdoors or indoors, for example, in a commercial indoor space, such as a mall.

As can be understood from FIG. 1, the exposure value of the asset 102 may be determined based on location information, digital elevation model data, and transport data. In one implementation, the asset 102 is defined by geographical coordinates for a location point 106 where the asset 102 is or may be positioned, and location data for one or more exposure points with respect to the asset 102 are obtained. The location data includes information corresponding to the asset 102, including, without limitation, a size of the asset 102, an orientation of the asset 102, an elevation of the asset 102 above the location point 106, a type of media that is or may be displayed with the asset 102, whether and how the asset 102 is illuminated (e.g., natural light, ambient light, and/or via dedicated light sources), and the like.

The location data provides exposure information with respect to the conditions in which the asset 102 may be viewed and the quality of the view. For example, the size of the asset 102 informs a determination of a maximum distance from which the asset 102 may be viewed such that the media content displayed on the asset 102 may be absorbed. Similarly, the orientation of the asset 102 informs an analysis of which lines of sight are more valuable based on angles of view for a consumer. A duration of a line of sight between the consumer and the asset 102 provides information that may be used to determine the value of the asset 102 with respect to the likelihood of a consumer viewing the asset 102 during travel along the travel segment 104.

In one implementation, the digital elevation model data represents an elevation of surface terrain as well as various features projecting from the surface terrain in the region in which the location point 106 of the asset 102 is positioned. The digital elevation model data may include, without limitation: an elevation of the location point 106; elevation information of features and items between the asset 102 and locations along the travel segment 104; heights, positions, and general plan areas of features in a geographical area, such as buildings, trees, other vegetation, lampposts, traffic lights, fixed assets, features or items that may obscure exposure of the asset 102, and features or items that may enhance exposure of the asset 102 (e.g., light sources); and the like. In one implementation, the digital elevation model data is associated with a cell in a matrix of data, and the smaller each cell is defined, the more granular the digital elevation model data is, which provides a more precise exposure evaluation. The location information for the exposure points and the digital elevation model data may be combined to create a viewshed 108. In FIG. 1, outer lines of sight of the viewshed 108 are represented by dotted lines. Further, it will be appreciated by those skilled in the art that the representation of the viewshed 108 in FIG. 1 is a 2D or planimetric location of viewability.

The viewshed 108 is intersected with transport information for the travel segment 104 to obtain exposure value information. In one implementation, the transport information includes routing and speed information. The routing and speed information may be obtained from one or more transport databases, surveys, reports, vendors, and/or other sources. The routing and speed information includes, but is not limited to, data from GPS devices, schedules, posted speed limits, measured speeds captured in real time, historical or statistical speed data, mode of transportation (e.g., walking, driving, biking, etc.), and/or the like. The routing and speed information indicates the direction and speed of consumers along the travel segment 104. The routing and speed information may be historical or provided in substantially real time.

In one implementation, the transport information is intersected with the data corresponding to the viewshed 108 by comparing elevations of locations or cells along lines of sight between the asset 102 and various locations along the travel segment 104. From this information, it may be determined which paired locations have lines of sight between the asset 102 and those locations. A speed of an actual or potential consumer along the travel segment 104 is determined for the various locations, providing information regarding the duration of the persistence of the line of sight along the locations on the travel segment 104.

In other words, exposure value information is determined from the intersection of the transport information with the information corresponding to the viewshed 108. From the exposure value information, the opportunities, risks, and value presented by the asset 102 may be assessed. In one implementation, the exposure value information provides a distance and a time during which a consumer is exposed to the asset 102 along the travel segment 104. Further, for the asset 102, the exposure value information may provide: an average exposure distance and time based on planned or marked speeds or historical average speed data; an average exposure distance and time for a particular time; an exposure distance and time in substantially real time based on a real time feed of speed information; a maximum exposure distance and time; a minimum exposure distance and time; statistical representations of exposure distance and time; optimal viewing locations; representations of the above accounting for parameters of the asset 102, such as size and illumination; and the like. The optimal viewing locations correspond to locations providing a substantially continuous view along one or more travel segments as opposed to locations providing an interrupted view where the asset comes in and out of sight.

Further, the exposure value assessment systems and methods may be used for a variety of purposes including, without limitation, auditing, identifying an azimuth of the asset 102 location point 106, estimating populations that may view the asset 102, determining a dwell time for where the asset 102 is digital, and determining an overall metric for the asset 102. With respect to auditing, the exposure value information is determined for a primary approach of the asset 102 to identify if it is necessary to audit an alternative approach. From a planning perspective, different location angles may be tested to determine the effect on visibility of the asset 102 to potential consumers. The exposure value assessment system enables the identification of the azimuth of the asset 102 by permits quick angle to travel segment 104 analysis.

The populations that may view the asset 102 may be estimated by combining the viewshed 108 with imagery to provide a sense of congested traffic (e.g., foot traffic) and where the asset 102 will be visible. Generally, digital assets are valued and sold based on dwell time (i.e., a time when congestion surrounding the location of the digital asset is maximized). The exposure value assessment system provides suggestions for an optimal location for a particular type of advertisement based on the dwell time.

Finally, the overall metric for the asset 102 permits the rating and ranking of the asset 102 based on the exposure. In one example, a high ranking of a 5 means that an obstruction percentage on a primary 500 ft approach is between 5 and 10%. The metric provides the buying or marketing community with means for evaluating preferred locations for assets as well as for providing insight for the operators into what locations may need updating or abandonment. Thus, increasing revenue for operators and return on advertising and marketing investments for the buyers/marketers.

In one implementation, additional data is utilized to further focus the assessment of exposure value of the asset 102. Such additional data may include consumer information, nearby attraction information, distraction information, and any other information that may affect the viewing or exposure of the asset 102 to consumers.

Consumer information includes information corresponding to an actual or target audience and/or information corresponding to one or more particular consumers. In one implementation, the consumer information is based on demographic data, census data, survey data, purchase history for one or more particular consumers, consumer preferences set and submitted by one or more particular consumers, or any other information about actual or potential consumers. Nearby attraction information includes information indicating what places of interest, tourist sites, commercial businesses, facilities, hospitals, schools, retail stores, restaurants, etc. are located in a vicinity near the asset 102. Distraction information includes information corresponding to competing assets or other distractions that are or may be present within the viewshed 108. In some implementations, information accounting for reasonable visibility (i.e., not just line of sight to the asset 102), including a size of the asset 102 and illumination, is used in the generation of the viewshed 108 and/or the assessment of the exposure value of the asset 102.

Such information provides data on who is viewing the asset 102 in addition to how it is viewed. Knowing how the asset 102 is being viewed and the actual consumer audience permits configuration of the asset 102 to better reach a target audience. For example, a type of media content displayed with the asset 102 and the exposure duration of the media content may be configured based on this information. Exposure duration may be used to determine an optimal complexity of media content to ensure that the media content may be absorbed by consumers during the exposure duration. For example, for shorter exposure durations media content should be relatively simple to ensure it may be quickly absorbed. Further, the transport information combined with the consumer information may indicate an optimal time (e.g., of day or week) to display certain media content to reach a target audience or to display media content for longer exposure durations (e.g., at red lights or during traffic congestion). Further, using this information, the asset 102 may be configured to rotate media content such that each media content message receives maximum exposure for its target audience. This increases the value of the asset 102 and/or permits companies to thoroughly research and identify the best asset to display their media content.

Additionally, one or more filters may be utilized to further focus the assessment of the exposure value of the asset 102. For example, the transport information and the viewshed 108 may be filtered to restrict the exposure value assessment to specific scenarios. For example, the transport information and the viewshed 108 may be filtered such that the viewshed 108 is restricted to a certain or optimum viewing angle of the asset 102 by a consumer, a specific route for the travel segment 104, or the like. The transport information may be further filtered, for example, by speed, date range, time of day, type of traffic/mode of transportation for historical routing and speed data.

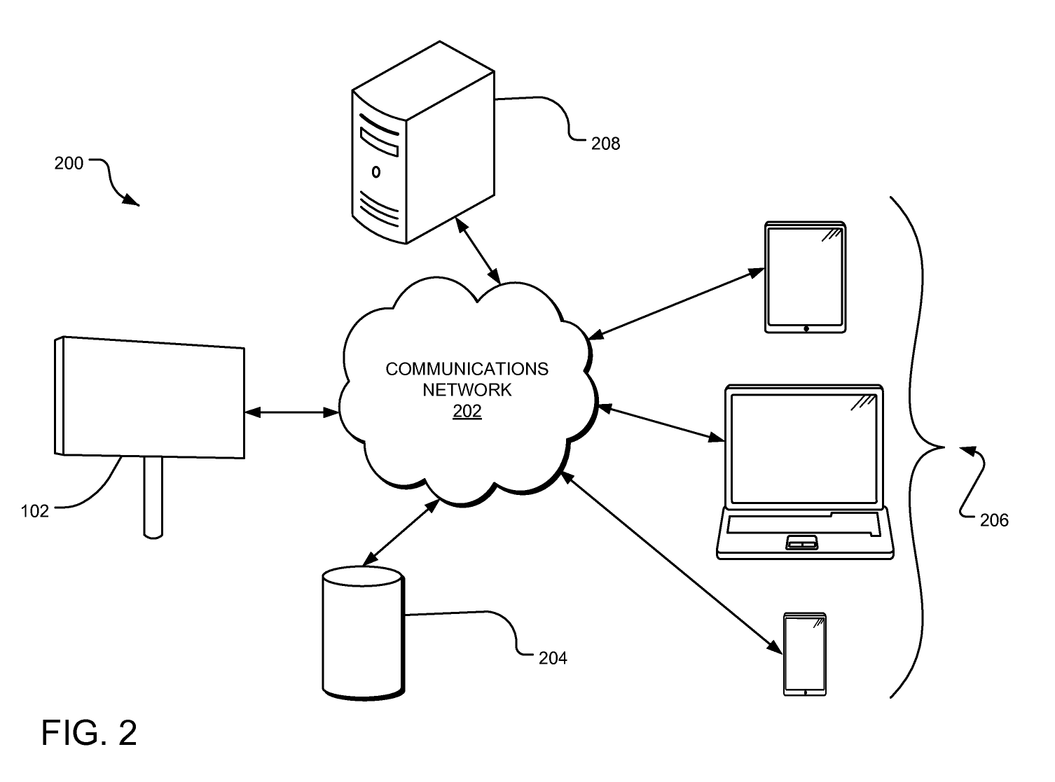

FIG. 2 is an example network environment 200 that may be useful in implementing the systems and methods for assessing an exposure value of one or more assets 102. As can be understood from FIG. 2, a communications network 202 (e.g., the Internet) is used by one or more computing or data storage devices (e.g., one or more databases 204) for implementing the systems and methods described herein. In one implementation, exposure value information and supporting data is accessed and interacted with using an exposure value assessment application via the network 202. Further, the assets 102 may be configured, updated, managed, and otherwise interacted with via the network 202.

In one implementation, a user may access and interact with the exposure value assessment application and exposure value information using a user device 206 communicatively connected to the network 202. The user device 206 is generally any form of computing device capable of interacting with the network 202, such as a personal computer, portable computer, mobile device, a tablet or slate (e.g., iPad), a multimedia console, etc.

In one implementation, the network 202 includes a server 208 hosting a website or an application that the user may visit to access the exposure value assessment application. The server 208 may be a single server, a plurality of servers with each such server being a physical server or a virtual machine, or a collection of both physical servers and virtual machines. In another implementation, a cloud hosts one or more components of the system. The user devices 206, the server 208, the assets 102, and other resources connected to the network 202 may access one or more other servers to access to one or more websites, applications, web services interfaces, storage devices, computing devices, etc. that are used to manage assets or evaluate exposure value. The server 208 may also host a search engine that the system uses for accessing and modifying exposure value information or media content.

As can be understood from FIG. 2, data that may be used to determine exposure value (e.g., location information, digital elevation model data, transport information, consumer information, etc.) received via the network 202 is stored in the database 204. In one implementation, a consumer has an account storing consumer information, including consumer preferences. In another implementation, a user has an account containing exposure value information for one or more assets owned, managed, rented, or otherwise related to the user. For example, the user may update or rotate media content or otherwise configure the asset 102 (e.g., set exposure duration for media content) via the network 202 using the exposure evaluation assessment application. In some implementations, one or more communications may be sent via the network 202 to various data sources to obtain current or real time data and update the database 204. Exposure duration of content on the asset 102 may be updated in substantially real time based on current transport data, such as routing and speed information or traffic control information (e.g., whether a light is red or green).

In one implementation, a user may subscribe or otherwise opt-in to a service where that the asset 102 uses the network 202 recognize when the user device 206 enters within the viewshed of the asset 102. Based on preferences set by the user, the asset 102 may automatically adjust the media content to present media content targeted at the set preferences. The user may provide information from which the system may correlate the user and the set preferences with one or more user devices 206 owned or used by the user. For example, if a user sets preferences to receive advertisements regarding a particular clothing store, the asset 102 may recognize the user device 206 entering the viewshed for the asset 102 and present media content advertising nearby locations of the clothing store.

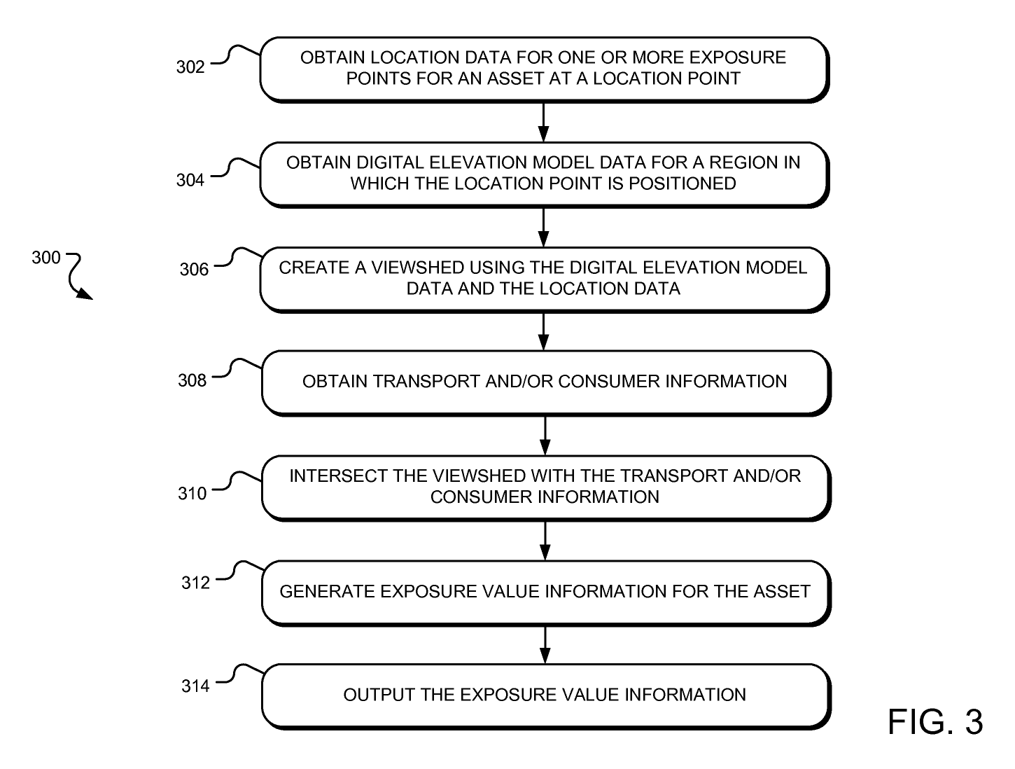

FIG. 3 is a flow chart illustrating example operations 300 for assessing the exposure value of one or more assets. In one implementation, the assets are OOH advertising assets, which may display digital, non-digital, rotating, and/or fixed media content. In other implementations, the assets are locations, events, attractions, sites, or other assets.

In one implementation, an obtaining operation 302 obtains location information for one or more exposure points for an asset positioned at a location point. The location data provides exposure information with respect to the conditions in which the asset may be viewed and the quality of the view. In one implementation, the location information includes a size of the asset, an orientation of the asset, an elevation of the asset above the location point, a type of media that is or may be displayed with the asset, whether and how the asset is illuminated, and the like.

An obtaining operation 304 obtains digital elevation model data for a region in which the location point of the asset is positioned. The digital elevation model data includes data corresponding to an elevation of surface terrain as well as various features projecting from the surface terrain in the region. In one implementation, the digital elevation model data includes: an elevation of the location point of the asset; elevation information of features and items between the asset and locations along a travel segment from which the asset may be viewed; heights, positions, and general plan areas of features in a geographical area, such as buildings, trees, other vegetation, lampposts, traffic lights, fixed assets, features or items that may obscure exposure of the asset, and features or items that may enhance exposure of the asset; and the like.

A creating operation 306 creates a viewshed using the location information for the exposure points and the digital elevation model data. An obtaining operation 308 obtains transport information associated with the travel segment and/or consumer information. In one implementation, the transport information includes routing and speed information, and the consumer information includes demographic data, census data, and consumer preferences. The routing and speed information indicates the direction and speed of consumers along the travel segment and may be historical or provided in substantially real time.

An intersecting operation 310 intersects the viewshed with the transport information and/or the consumer information from a generating operation 312 generates exposure value information for the asset. An outputting operation 314 outputs the exposure value information. The exposure value information may be presented and interacted with in a variety of formats, including, without limitation, via a user interface, a print out, a data feed, etc. In one implementation, the outputting operation 314 presents the exposure value information in a user manipulable and understandable form. For example, the exposure value information may be presented on a user interface displaying: locations and orientations of one or more assets, transport information for one or more travel segments that may be exposed to the assets, viewshed data corresponding to the assets, locations where the line of sight is obscured by fixed features, travel segments where a consumer would be exposed to the asset for more than a fleeting opportunity (e.g., exposed for greater than four seconds), and/or the like.

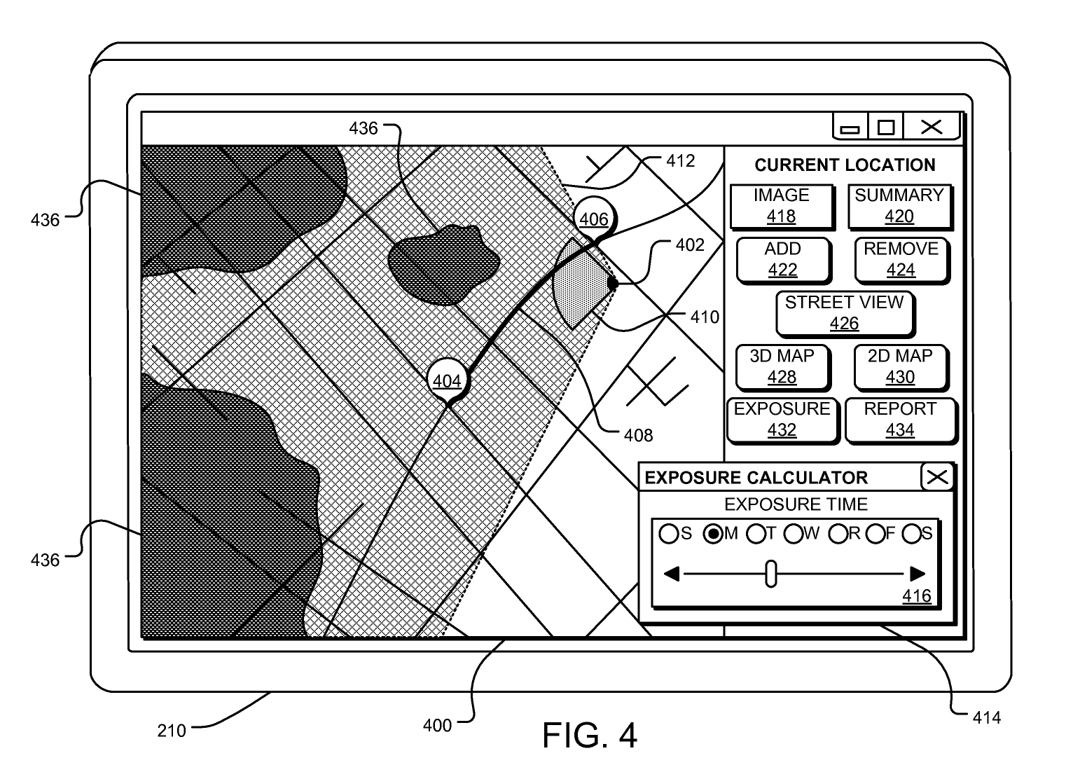

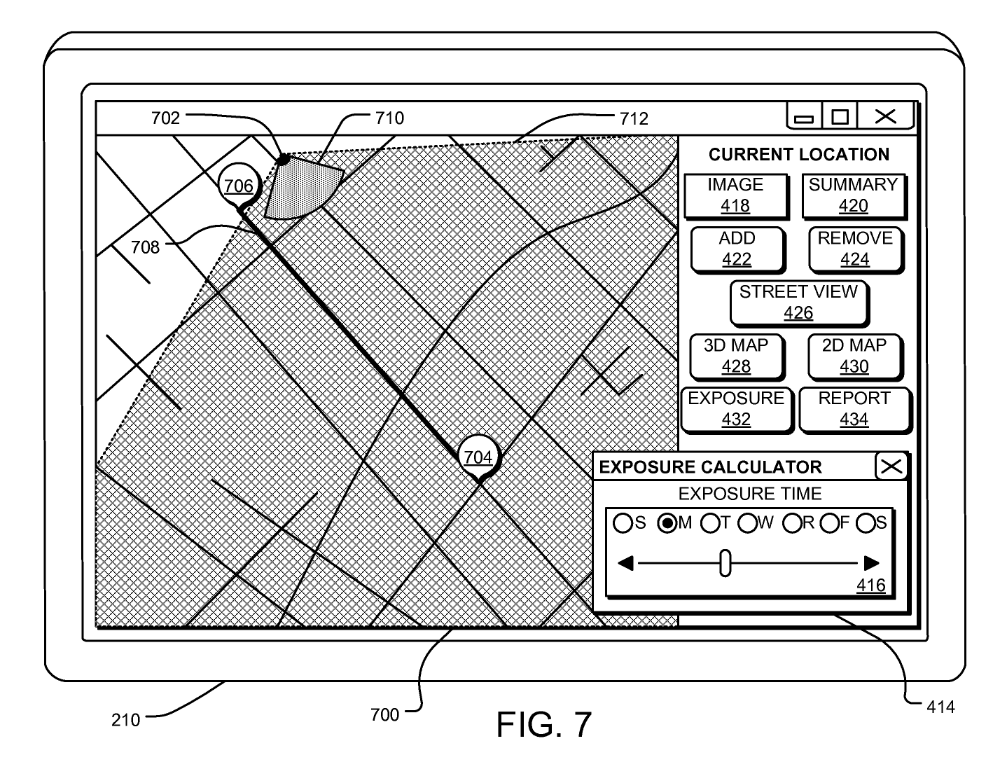

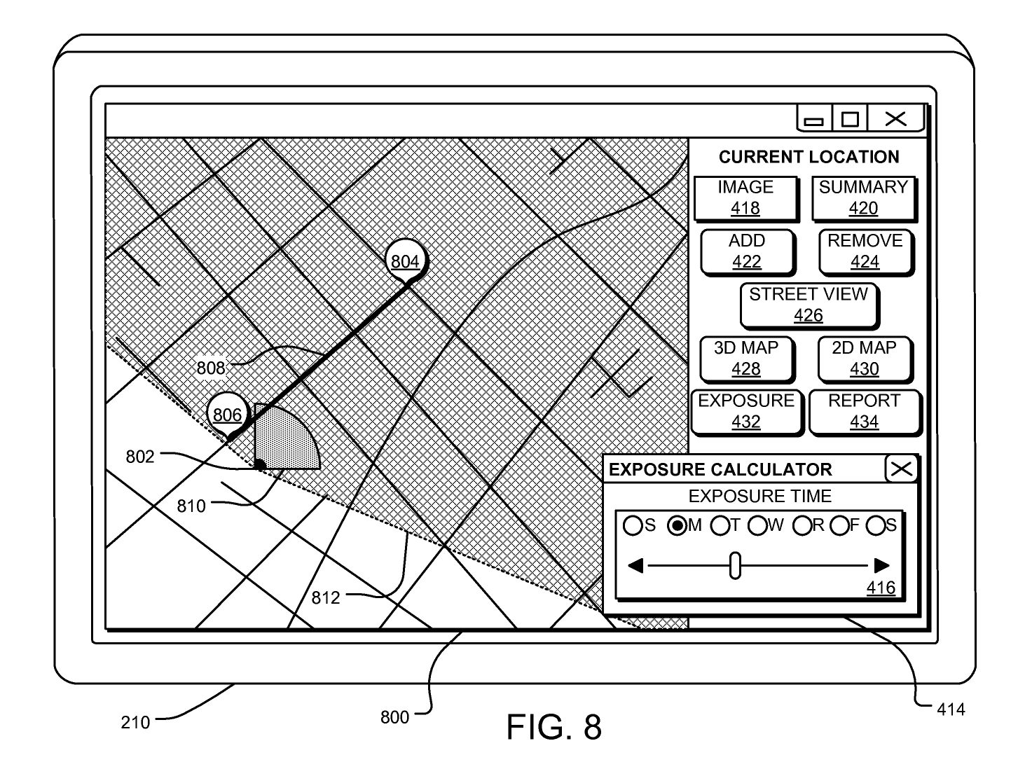

FIGS. 4-8 show an example user interface 210 through which access to and exposure value information are controlled with an exposure value assessment application. As shown in FIGS. 4-8, the exposure value information may be presented in the form of an overlaid map. It will be appreciated by those skilled in the art that such depictions are exemplary only and not intended to be limiting.

In one implementation, a user, such as an owner of an asset, a prospective buyer or renter of the asset, consumer, and/or another interested party, accesses the exposure value assessment application via a link in a user or administrator account designed to manage one or more assets. In another implementation, the user connects directly to a homepage of the exposure value assessment application.

Referring to FIG. 4, the user interface 210 shows a viewshed analysis and exposure presentation 400 of an OOH asset 402 to a consumer traveling from a first point 404 to a second point 406 along a selected travel segment 408. In one implementation, a user may place the first point 404 and the second point 406 on the map depicted in the exposure presentation 400. Along the travel segment 408, the OOH asset 402 is visible, as there are no obstructions present, providing the best possible exposure rating. If a different route were chosen that includes portions transiting an obscured area 436, the OOH asset 402 would not be visible along these portions of the route. In these instances, a lower exposure value would be calculated.

An exposure direction 410 of the OOH asset 402 is shown in FIG. 4 as a 90° fan shape shaded with a dotted pattern. The exposure direction 410 is based on an orientation of the OOH asset 402. A calculated viewshed 412 is depicted facing the exposure direction 410. The viewshed 412 is shown in FIG. 4 as a square pattern. In some implementations, the viewshed 412 is shaded to indicate whether a line of site is obscured. For example, the viewshed 412 may be shaded with a first color or pattern representing portions that would have an obscured view of the OOH asset 402 by intervening elevation features (e.g., buildings) (e.g., as shown in FIG. 4 as the obscured areas 436), with a second color or pattern representing a partial obscuring of the OOH asset 402, and with a third color or pattern representing a clear line of sight to the OOH asset 402.

In one implementation, the travel segment 408 represents the locations or points along a route from the first point 404 to the second point 406 where there is an opportunity for a consumer to be exposed to the OOH asset 402. Generally, the longer the duration of the exposure of the consumer to the OOH asset 402 in a continuous fashion, the more valuable the OOH asset 402. Thus, in one implementation, an exposure calculator 414 may be used to select a time (e.g., day of the week, time of day, or the like) and an exposure duration (e.g., in seconds). The selected time affects the number of potential consumers moving along the travel segment 408. In one implementation, the exposure calculation 414 includes parameters 416 for selecting the time and exposure duration. In the example shown in FIG. 4, the selectable parameters 416 include a movable cursor for selecting the exposure duration (e.g., from 4 to 26 seconds) and dials for selecting a day of the week. Selecting longer or shorter exposure durations lengthens or shortens the travel segment 408 to reflect the locations where the consumer would be exposed for at least the selected exposure duration.

The exposure presentation 400 may further include additional views and data. In one implementation, an image 418 displays a view of the OOH asset 402 (e.g., as it would be viewed along the travel segment 408, a stock image of the OOH asset 402, or an overlaid image of OOH asset 402 with potential media content), and a summary 420 providing location data for the OOH asset 402, including a size of the OOH asset 402 and whether it is illuminated. The exposure presentation 400 may further include one or more action buttons, including: an add button 422, a remove button 424, a street view button 426, a 3D map button 428, a 2D map button 430, an exposure button 432, and a report button 434. Additionally, in one implementation, the exposure presentation 400 includes a window or selectable feature (not shown) with which a user can rate the OOH asset 402 after analyzing the exposure value of the OOH asset 402 along various travel segments and comparing the OOH asset 402 with other OOH assets.

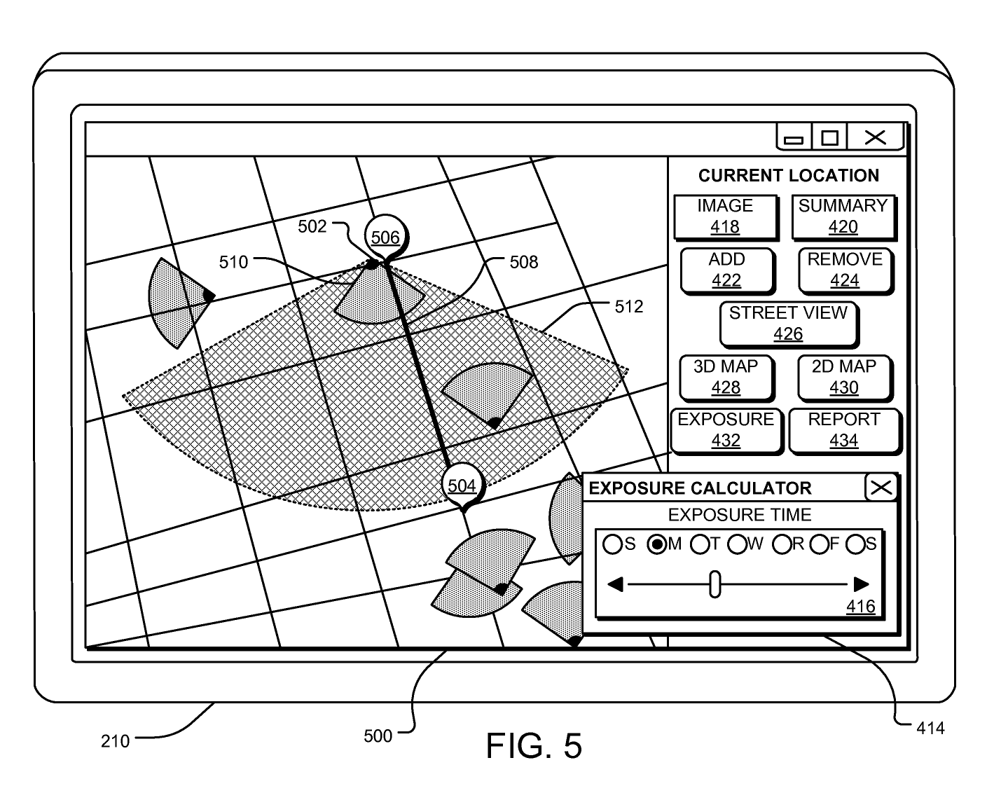

FIG. 5 illustrates a viewshed analysis and exposure presentation 500 of an OOH asset 502 with other OOH assets in the vicinity. In the example shown in FIG. 5, seven OOH assets are displayed for exposure value assessment and comparison, and the OOH asset 502 is being evaluated for a travel segment 508 defined by a first point 504 and a second point 506 and exposure duration and time. While the OOH asset 502 is being analyzed, an exposure direction 510 and viewshed 512 for the OOH asset 502 along the travel segment 508 is shown. A comparison of the exposure value for each of the OOH assets permits the user, for example, to determine an appropriate rental amount for one of the OOH assets and focus marketing efforts on the OOH asset with the highest exposure value within budget.

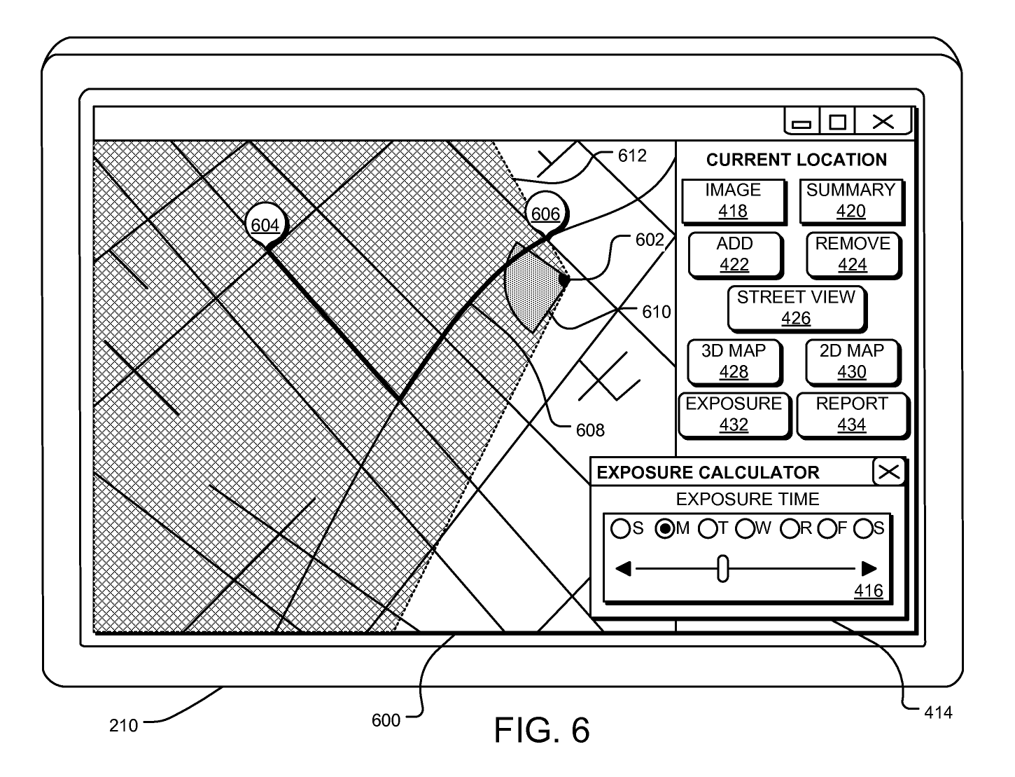

FIGS. 6-8 show the user interface 210 displaying viewshed analyses and exposure presentations 600, 700, and 800 of other OOH assets 602, 702, and 802 along different routes. As shown in FIG. 6, a first point 604 and a second point 606 are placed on the exposure presentation 600. The points 604, 606 together with the selected exposure duration and time may be used to adjust the travel segment 608. An exposure direction 610 and viewshed 612 for the OOH asset 602 along the travel segment 608 is shown.

Similarly, a first point 704 and a second point 706 together with the selected exposure duration and time inform the travel segment 708. An exposure direction 710 and viewshed 712 for the OOH asset 702 along the travel segment 608 is shown. The exposure duration and time may be set for congested travel time based on historical data. Finally, a first point 804 and a second point 806 are placed on the exposure presentation 800. The points 804, 806 together with the selected exposure duration and time may be used to adjust the travel segment 808. An exposure direction 810 and viewshed 812 for the OOH asset 802 along the travel segment 808 is shown.

In some implementations, consumer information, such as demographic information, as described herein, may be overlaid on the exposure presentations 400, 500, 600, 700, and 800 to further parse and analyze the exposure value of the OOH assets 402, 502, 602, 702, and 802 based, for example, on a target consumer market (e.g., age or gender segments of the market). In one implementation, the consumer information may be used to generate a relative ranking or to otherwise filter assets to focus on the intended audience.

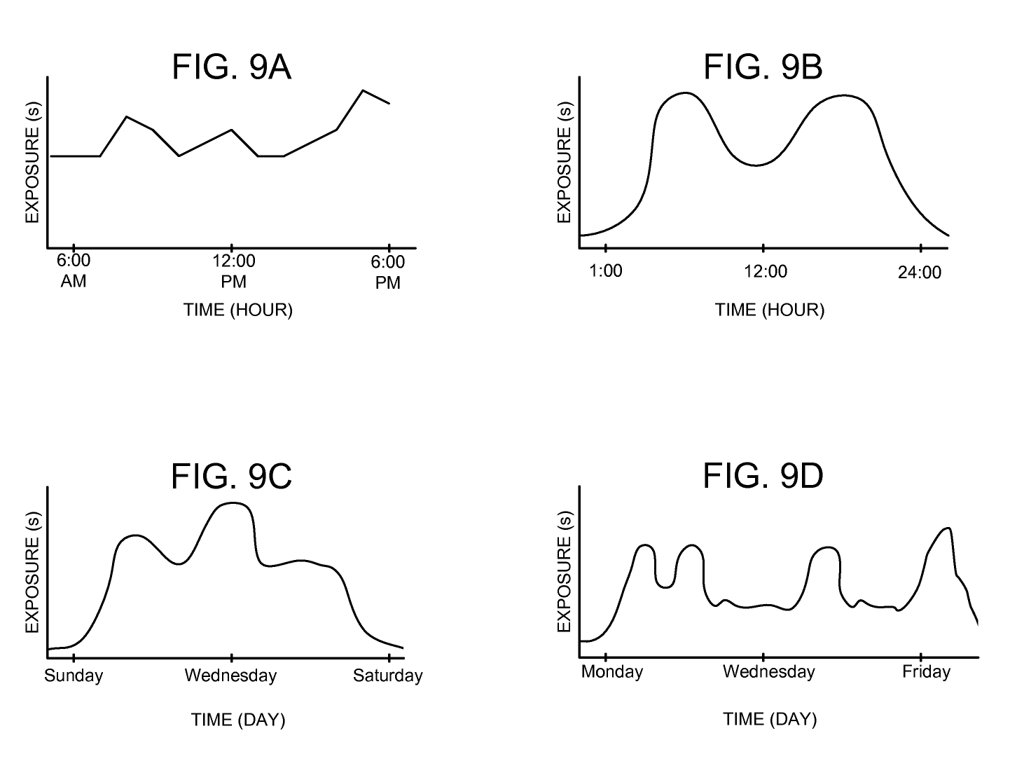

Another example format for presenting the exposure value information is illustrated in FIGS. 9A-9D, which show graphs depicting an effect of an exposure assessment on a duration of exposure of an asset along a travel segment.

Turning to FIG. 9A, historical transport information at various times during a weekday is used to calculate an exposure duration for an asset for those times. In the example shown in FIG. 9A, the graph showing exposure value indicates that a travel segment is congested during typical morning and afternoon rush hour times, with the longest average exposure duration being around 5:30 PM. The longest average exposure duration represents the optimal time for consumers to have an opportunity to view and absorb the media content of the asset. Applying consumer information about the likely destinations and interests of consumers traveling along the travel segment at the time corresponding to the longest average duration would suggest the media content that would receive the most return from being exposed to consumer and how the media content should be presented.

FIG. 9B similarly utilizes historical transport information at various times during a weekday to calculate an exposure duration for an asset for those times and indicates that a travel segment is congested during typical morning and afternoon rush hour times, with the longest average exposure duration being in the afternoon rush hour period. The average, shortest, and longest exposure durations may be used for a variety of purposes in configuring an asset or deciding whether to invest in an asset. For example, the exposure durations affect the analysis of what the complexity of media content should be. Stated differently, short exposure durations generally correspond to less complex media content because the consumer has less time to absorb the content.

Turning to FIGS. 9C and 9D, historical transport information at various times (i.e., days) during a week is used to calculate an exposure duration for an asset for those times. In the example shown in FIG. 9C, the graph showing exposure value indicates that a travel segment has a longest average exposure duration on Wednesday. In the example shown in FIG. 9D, the graph showing exposure value indicates that a travel segment has an exposure duration that varies over a day and over a week.

Other calculations of exposure value information and presentations of this information may be generated and displayed via the user interface 210. For example, the exposure presentation may include, without limitation, a percentage of viewable area, an average exposure time, variances in exposure time, median exposure, longest/shortest exposure, exposure time by mode of transportation (e.g., vehicle, walk, bike, train, bus, public mode, private modes, etc.), or other statistical, visual, time, or area based representations and calculations.

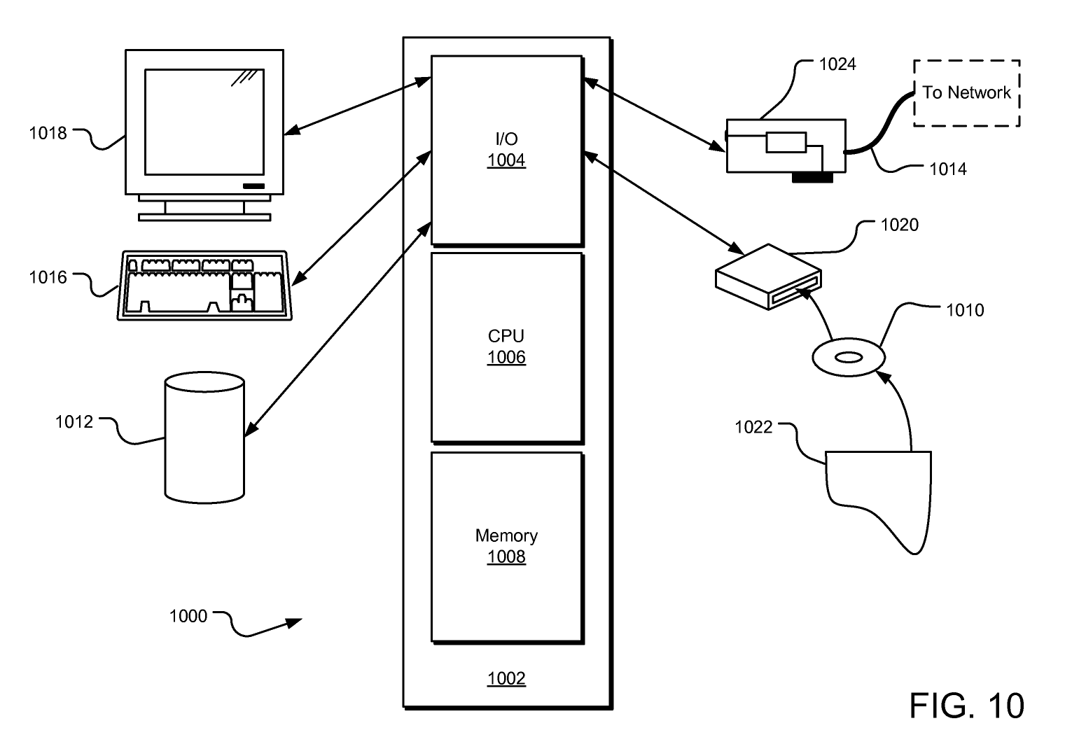

FIG. 10 is an example computing system 1000 that may implement various systems and methods discussed herein. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 10 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer, such as one or more external computers made available via a cloud computing architecture. The presently described technology is optionally implemented in software devices loaded in memory 1008, stored on a configured DVD/CD-ROM 1010 or storage unit 1012, and/or communicated via a wired or wireless network link 1014, thereby transforming the computer system 1000 in FIG. 10 to a special purpose machine for implementing the described operations.

The I/O section 1004 is connected to one or more user-interface devices (e.g., the user devices 210, a keyboard 1016 and a display unit 1018), a disc storage unit 1012, and a disc drive unit 1020. Generally, the disc drive unit 1020 is a DVD/CD-ROM drive unit capable of reading the DVD/CD-ROM medium 1010, which typically contains programs and data 1022. Computer program products containing mechanisms to effectuate the systems and methods in accordance with the presently described technology may reside in the memory section 1004, on a disc storage unit 1012, on the DVD/CD-ROM medium 1010 of the computer system 1000, or on external storage devices made available via a cloud computing architecture with such computer program products, including one or more database management products, web server products, application server products, and/or other additional software components. Alternatively, a disc drive unit 1020 may be replaced or supplemented by a floppy drive unit, a tape drive unit, or other storage medium drive unit. The network adapter 1024 is capable of connecting the computer system 1000 to a network via the network link 1014, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets, multimedia consoles, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are examples of communications devices for and other means of establishing a communications link between the computers may be used.

In an example implementation, location information, digital elevation model data, transport information, consumer information, the exposure value assessment application, a plurality of internal and external databases (e.g., the database 206), source databases, and/or data cache on cloud servers are stored as the memory 1008 or other storage systems, such as the disk storage unit 1012 or the DVD/CD-ROM medium 1010, and/or other external storage devices made available and accessible via a cloud computing architecture. Exposure value assessment software and other modules and services may be embodied by instructions stored on such storage systems and executed by the processor 1002.

Some or all of the operations described herein may be performed by the processor 1002. Further, local computing systems, remote data sources and/or services, and other associated logic represent firmware, hardware, and/or software configured to control operations described herein. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 1002 and a user may interact with a Graphical User Interface (GUI) (e.g., the user interface 210) using one or more user-interface devices (e.g., the keyboard 1016, the display unit 1018, and the user devices 1004) with some of the data in use directly coming from online sources and data stores. The system set forth in FIG. 10 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
obtaining location information for an asset at a location point, the location information reflecting viewing conditions of the asset;
obtaining digital elevation model data for a region in which the location point of the asset is positioned;
generating a viewshed based on the location information and the digital elevation model data; and
generating exposure value information by intersecting the viewshed with transport information using a processor.

2. The method of claim 1, wherein the location information includes at least one of: a size of the asset, an orientation of the asset, an elevation of the asset above the location point, a type of media for display with the asset, or illumination of the asset.

3. The method of claim 1, wherein the digital elevation model data includes at least one of an elevation of the location point of the asset or elevation information of features and items between the asset and locations along a travel segment from which the asset may be viewed.

4. The method of claim 1, wherein the transport information includes routing and speed information.

5. The method of claim 4, wherein the routing and speed information indicates a direction and a speed of one or more consumers along a travel segment from which the asset may be viewed.

6. The method of claim 4, wherein the routing and speed information is historical.

7. The method of claim 4, wherein the routing and speed information is obtained in substantially real time.

8. The method of claim 1, wherein the exposure value information is further generated based on consumer information.

9. The method of claim 8, wherein the consumer information corresponds to an target audience.

10. The method of claim 8, wherein the consumer information corresponds to one or more particular consumers.

11. The method of claim 10, wherein the consumer information corresponding to one or more particular consumer includes at least one of: consumer preferences or purchase history.

12. The method of claim 8, wherein the consumer information includes census data.

13. The method of claim 1, wherein the exposure value information is further generated based on nearby attraction information.

14. The method of claim 1, wherein the exposure value information is further generated based on a size and illumination of the asset.

15. The method of claim 1, wherein the exposure value information is further generated based on information corresponding to competing assets positioned within the viewshed.

16. The method of claim 1, wherein the exposure value information is further generated based on information corresponding to distractions positioned within the viewshed.

17. The method of claim 1, wherein the exposure value information is further generated based on an optimum viewing angle.

18. One or more tangible computer-readable storage media storing computer-executable instructions for performing a computer process on a computing system, the computer process comprising:
obtaining location information for an asset at a location point, the location information reflecting viewing conditions of the asset;
obtaining digital elevation model data for a region in which the location point of the asset is positioned;
generating a viewshed based on the location information and the digital elevation model data; and
generating exposure value information by intersecting the viewshed with transport information.

19. A system comprising:
an exposure value assessor executable by a processor and configured to generate exposure value information for an asset at a location point by intersecting a viewshed with transport information, the viewshed being generated based on location information reflecting viewing conditions of the asset and digital elevation model data for a region in which the location point of the asset is positioned.

20. The system of claim 19, wherein the transport information includes routing and speed information.
